(19) United States
(12) Patent Application Publication
(10) Pub. No.: US 2010/0328044 A1
(43) Pub. Date: Dec. 30, 2010

(54) INDUCTIVE POWER SYSTEM AND METHOD OF OPERATION

(75) Inventors: Eberhard Waffenschmidt, Eindhoven (NL); Matthias Teders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/446,283

(22) PCT Filed: Oct. 16, 2007
(86) PCT No.: PCT/IB07/54204

§ 371 Date: Sep. 15, 2010

(30) Foreign Application Priority Data
Oct. 26, 2006 (EP) 06122972.0

(51) Int. Cl. H04Q 5/22; H02J 17/00

(52) U.S. Cl. 340/10.4; 307/104

(57) ABSTRACT

An inductive power pad (100) includes a plurality of transmitting inductors (120) and a respective plurality of detector circuits (140). Each transmitting inductor (120) is operable to provide inductive energy to a power receiver circuit (150). Each detector circuit (140) corresponds to one of the plurality of transmitting inductors (120) and each detector circuit (140) is operable to electromagnetically sense a power receiver circuit (150) in proximity thereto. Each detector circuit upon electromagnetically sensing a power receiver circuit, is further operable to control switching of its corresponding transmitting inductor to a power supply (130), thereby providing a supply voltage to said corresponding transmitting inductor, said supply voltage operable to generating inductive energy (110) for transmission to said power receiver circuit.

### FIELD OF THE INVENTION

The present invention relates to inductive power systems and methods of operation, and more particularly to inductive power systems operable to electromagnetically sense the presence of a power receiver circuit to which inductive energy is to be transferred.

### BACKGROUND

A large percentage of present day electronics operate wirelessly, and this trend is expect to expand in the future. Portable appliances such as cell-phones, PDA, remote controls, notebooks, lamps etc., represent only the beginning of what is expected to be a growing number of wireless devices in various industrial sectors.

Portable appliances typically require power for operation, that power coming in the form of portable power storage in the form usually of rechargeable or replaceable batteries. Rechargeable batteries are seen as particularly advantageous, as they avoid the necessity of frequent replacement. Rechargeable batteries are often recharged using induction means, whereby an inductive power pad may be used to provide inductive energy to a power receiver circuit located within the portable appliance.

Use of inductive power pads are not without drawbacks. In particular, conventional inductive power pads emit strong inductive fields which can interfere with and produce harmful interactions with other electrical and biological systems in close proximity. These fields can produce eddy currents in unprotected electronics, damaging or destroying them, as well as interfere with biological systems and implants.

### SUMMARY

It may be desirable to provide an improved inductive power system and method of operation operable to provide inductive energy in a managed sense, either to a recognized device or, to a power receiver circuit which is positioned locally over a specific area of a inductive power pad as opposed to over the entire area of the inductive power pad.

This need may be met by an inductive power system and method of operation according to the independent claims.

In one embodiment of the invention, an inductive power pad is presented and includes at least one, and in a particular embodiment, a plurality of transmitting inductors. The inductive power pad further includes a corresponding at least one, and in a particular embodiment, a respective plurality of detector circuits, each detector circuit having one corresponding transmitting inductor. Each transmitting inductor is operable to provide inductive energy to a power receiver circuit, and each detector circuit is operable to electromagnetically sense a power receiver circuit. Furthermore, each detector circuit, upon electromagnetically sensing a power receiver circuit, is operable to control switching of its corresponding transmitting inductor to a power supply, thereby applying a supply voltage to its corresponding transmitting inductor. The supply voltage is operable to generating inductive energy for transmission to the power receiver circuit.

In another embodiment of the invention, an inductive power system is presented. The inductive power system includes a power receiver circuit operable to receive inductive power, and an inductive power pad, as described above and herein.

In still a further embodiment of the invention, a method for charging a power receiver circuit using an inductive power pad is presented. The inductive power pad includes at least one, and in a particular embodiment, a plurality of detector circuits. The inductive power pad further includes a corresponding at least one, and in a particular embodiment, a respective plurality of detector circuit, each detector circuit operable to electromagnetically sense a power receiver circuit, and each detector circuit coupled to a corresponding transmitting inductor which is operable to provide inductive energy to the power receiver circuit. The method includes the one or more of the detector circuits electromagnetically sensing a power receiver circuit proximate thereto, and in response coupling the corresponding transmitting inductor to a power supply. A supply voltage is coupled to the corresponding transmitting inductor, the supply voltage generating inductive energy which is transferred to the power receiver circuit.

It may be seen as a gist of an exemplary embodiment of the present invention that a power receiver circuit in proximity to a power inductive pad is electromagnetically sensed by a detector circuit, the detector circuit having a corresponding transmitting inductor for providing inductive energy to the power receiver circuit. The detector circuit, upon electromagnetically sensing the power receiver circuit is further operable to control switching of its corresponding transmitter inductor to a power supply, thereby applying a supply voltage to be supplied to the transmitting inductor. Inductive energy is thereby generated, and transferred to the power receiver circuit.

The following describes exemplary features and refinements of the inductive power pad in accordance with the invention, although these features and refinements will also apply to the inductive power system, and the system's method of operation as well.

In one embodiment, the inductor power pad includes a plurality of detector circuits, each of the plurality of detector circuits is switchably coupled between its corresponding transmitting inductor and the power supply (130). Further exemplary, each of the plurality of detector circuits is operable to couple its corresponding transmitting inductor to the power supply when the detector circuit inductively detects a magnetic field node of the power receiver circuit. The magnetic field node is operable to modulate one of more operating parameters P of the detector circuit, such modulation indicating the presence of the power receiver circuit. Such an embodiment is advantageous in inductively sensing the power receiver circuit.

In another embodiment, the aforementioned magnetic field node comprises a soft magnetic layer disposed within the power receiver circuit. Each of the plurality of detector circuits is operable to generate a magnetic field which can be inductively modulated by the soft magnetic layer, whereby each detector circuit exhibits a first operating parameter P₁ when the soft magnetic layer inductively modulates the generated magnetic field, and a second operating parameter P₂ when the soft magnetic layer does not inductively modulate the generated magnetic field. Each detector circuit is further operable to couple the corresponding transmitting inductor to the power supply when operating at the first operating parameter P₁, and wherein said each detector circuit is operable to decouple the corresponding transmitting inductor from the power supply when operating at the second operating parameter P₂. This embodiment advantageously uses a soft magnetic layer within the power receiver circuit as a detection means, thus the power receiving circuit does not expend power in the detection process.

In a specific example of the foregoing embodiment, each detector circuit includes a detector inductor having a first inductance value L₁ in the presence of the magnetic field node of the power receiver circuit, and a second inductance value L₂ outside the presence of the magnetic field node of the power receiver circuit (150). The inductance value of the detector inductor provides an accurate and low cost means to detect the magnetic field node of the soft magnetic layer.

In another embodiment, the magnetic field node is provided by a resonant circuit disposed within the power receiver circuit. Each of the plurality of detector circuits is operable to generate a magnetic field which can be inductively modulated by the resonant circuit, as the resonant circuit is tuned substantially to the frequency of the generated ac magnetic field. Each detector circuit exhibits a first operating parameter P₁ when the resonant circuit inductively modulates the generated magnetic field, and a second operating parameter P₂ when the resonant circuit does not inductively modulate the generated magnetic field. Each detector circuit is further operable to couple the corresponding transmitting inductor to the power supply when operating at the first operating parameter P₁, and wherein said each detector circuit is operable to decouple the corresponding transmitting inductor from the power supply when operating at the second operating parameter P₂. This embodiment provides similar advantages to the aforementioned embodiment employing a soft magnetic layer, albeit with a resonant circuit which may be provided in a more miniaturized form.

In a further embodiment, the magnetic field node is provide by a hard magnetic layer disposed within the power receiver circuit, the hard magnetic layer operable to provide a dc magnetic field. In this embodiment, each of the plurality of detector circuit is operable to sense the dc magnetic field emanating from the hard magnetic layer, each detector circuit exhibiting a first operating parameter P₁ when the detector circuit inductively detects the dc magnetic field emanating from the hard magnetic layer, and a second operating parameter P₂ when the detector circuit does not inductively detect the dc magnetic field emanating from the hard magnetic layer. Each detector circuit further is operable to couple the corresponding transmitting inductor to the power supply when operating at the first operating parameter P₁, and wherein said each detector circuit is operable to decouple the corresponding transmitting inductor (120) from the power supply when operating at the second operating parameter P₂. This embodiment provides similar advantages of the aforementioned embodiments in which power from the power receiver circuit is not required, and also obviates the need for the detector circuit to generate an ac magnetic field for detection of the power receiver circuit.

In a further embodiment of the invention, a plurality of detector circuits are employed, each detector circuit including a separate ac generator operable to provide a separate supply voltage to its respective transmitting inductors. Further exemplary, a first of the ac generators is operable to supply its generated power supply voltage to a first transmitting inductor at a first phase or frequency, and a second of the ac generators is operable to supply its generated power supply voltage to a second transmitting inductor at a second phase or frequency, the first and second phase and/or frequency providing an offset (e.g., an orthogonal) from each other. This arrangement allows increased immunity to interference during concurrent power transfer by two or more transmitting inductors, as the first and second transmitting inductors transfer their inductive energy at different phases or frequencies.

In a further embodiment of the invention, each detector circuit includes an RFID sensor circuit operable to detect an RFID signal emanated from a power receiver circuit. Further specifically, the inductive power pad further includes an RFID receiver coupled to receive an RFID signal from the RFID sensor circuit. The RFID receiver is further operable to couple the power supply to one or more of the plurality of transmitting inductors in response to receiving a recognized RFID signal, and to decouple the power supply from one or more of the plurality of transmitting inductors when not receiving a recognized RFID signal by detector circuits. In a particular refinement, the RFID sensor is formed from a coil operable to detect load modulation of a passive RFID tag. Furthermore, a sensor bus is implemented to addressably couple each of the plurality of RFID sensors to the RFID receiver, and a power supply bus is implemented to addressably couple each of the plurality of transmitting inductors to the RFID receiver.

The following describes exemplary features and refinements of the inductive power system in accordance with the invention, although these features and refinements will also apply to the inductive power pad, and the system's method of operation as well.

In an exemplary embodiment, the power receiver circuit includes a magnet field node operable for magnetic field communication with the inductive power pad. In specific embodiments, the magnetic field node includes a soft magnetic layer or a resonant circuit, each of which is operable to modulate an ac magnetic field generated by the detector circuit of the inductive power pad. In another embodiment, the magnetic field node is provided by a hard magnetic layer disposed in the power receiver circuit, the hard magnetic layer operable to provide a dc magnetic field which is detectable by the detector circuit.

In another exemplary embodiment, the power receiver circuit includes comprises an RFID tag operable to emit an RFID signal. In a specific embodiment, the power receiver circuit is coupled to provide power to a foot switch controller, the foot switch controller operable to wireless control an x-ray apparatus.

The following describes exemplary features and refinements of the inductive power system method of operation in accordance with the invention, although these features and refinements will also apply to the inductive power pad and inductive power system as well.

In one embodiment, the operation of the at least one detector circuit electromagnetically sensing a power receiver circuit includes the operation of at least one detector circuit sensing proximity of a magnetic field node disposed in the power receiver circuit. In a particular refinement of this embodiment, the magnetic field node is a soft magnetic field layer, and the operation of the at least one detector circuit sensing proximity of a magnetic field node includes the operation of the least one detector circuit generating a magnetic field which can be inductively modulated by a soft magnetic layer. The at least one detector circuit is further operable to exhibit a first operating parameter P₁ when the soft magnetic layer inductively modulates the generated magnetic field, and a second operating parameter P₂ when the soft magnetic layer does not inductively modulate the generated magnetic field. The aforementioned operation of coupling the corresponding transmitting inductor to a power supply includes the operations of coupling the corresponding transmitting inductor to the power supply when the said at least one detector circuit operates at the first operating parameter P₁, and decoupling the corresponding transmitting inductor from the power supply when said at least one detector circuit operates at the second operating parameter P₂. This operation provides the aforementioned advantages in which detection of the power receiver circuit is made possible without the power receiver circuit consuming energy in the detection process.

In another embodiment, the magnetic field node in a resonant circuit disposed within the detector circuit. In this embodiment, the operation of the at least one detector circuit inductively sensing proximity of a magnetic field node includes the operations of the at least one detector circuit generating an ac magnetic field which can be inductively modulated by the resonant circuit. The at least one detector circuit is further operable to exhibit a first operating parameter P₁ when the resonant circuit inductively modulates the generated magnetic field, and a second operating parameter P₂ when the resonant circuit does not inductively modulate the generated magnetic field. The at least one detector circuit is further operable to perform the operations of coupling the corresponding transmitting inductor to the power supply when the said at least one detector circuit operates at the first operating parameter P₁, and decoupling the corresponding transmitting inductor from the power supply when said at least one detector circuit operates at the second operating parameter P₂. This operation provides the aforementioned advantages in which detection of the power receiver circuit is made possible without the power receiver circuit consuming energy in the detection process, and implementation of a resonant circuit may be more space efficient.

The operations of the foregoing methods may be realized by a computer program, i.e. by software, or by using one or more special electronic optimization circuits, i.e. in hardware, or in hybrid/firmware form, i.e. by software components and hardware components. The computer program may be implemented as computer readable instruction code in any suitable programming language, such as, for example, JAVA, C++, and may be stored on a computer-readable medium (removable disk, volatile or non-volatile memory, embedded memory/processor, etc.), the instruction code operable to program a computer of other such programmable device to carry out the intended functions. The computer program may be available from a network, such as the WorldWideWeb, from which it may be downloaded.

These and other aspects of the present invention will become apparent from and elucidated with reference to the embodiment described hereinafter.

### BRIEF SUMMARY OF THE DRAWINGS

FIG. 1A illustrates an exemplary block diagram of an inductive power system in accordance with the present invention.

FIG. 1B illustrates a second exemplary block diagram of an inductive power system in accordance with the present invention.

FIG. 2 illustrates a method of operating an inductive power system in accordance with the present invention.

FIG. 3A illustrates a first exemplary inductive power system in which a magnetic field is used to electromagnetically sense a power receiver circuit in accordance with the present invention.

FIG. 3B illustrates a first embodiment of the power receiver circuit shown in FIG. 3A in accordance with the present invention.

FIG. 3C illustrates an exemplary schematic of the power receiver circuit shown in FIG. 3B in accordance with the present invention.

FIG. 3D illustrates a second embodiment of the power receiver circuit shown in FIG. 3A in accordance with the present invention.

FIG. 3E illustrates a third embodiment of the power receiver circuit shown in FIG. 3A in accordance with the present invention.

FIG. 4 illustrates a schematic view of the exemplary inductive power system shown in FIG. 3 in accordance with the present invention

FIG. 5A illustrates a schematic view of a first exemplary detector circuit in accordance with the present invention.

FIG. 5B illustrates a schematic view of a second exemplary detector circuit in accordance with the present invention.

FIG. 6A illustrates a resonant frequency response of the detector circuit shown in FIG. 5A in accordance with the present invention.

FIG. 6B illustrates a voltage response of the detector circuit shown in FIG. 5A in accordance with the present invention.

FIG. 7 illustrates an exemplary switch employed in the detector circuit shown in FIG. 5 in accordance with the present invention.

FIG. 8A illustrates an exemplary inductive power system in which RFID signals are used to electromagnetically sense a power receiver circuit in accordance with the invention.

FIG. 8B illustrates a second exemplary embodiment of an RFID inductive power system in accordance with the invention.

FIG. 9 illustrates a foot switch controller incorporating an inductive power system in accordance with the present invention.

For clarity, previously identified features retain their reference indicia in subsequent drawings.

### DETAILED DESCRIPTION OF EXEMPLARY EMBODIMENTS

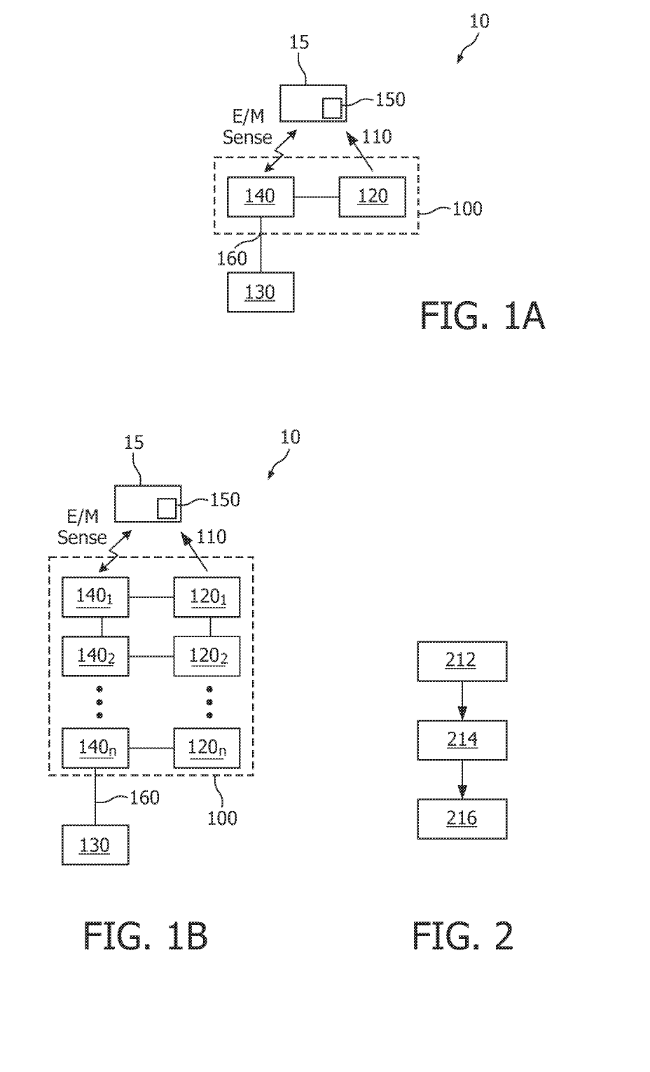

FIG. 1A illustrates an exemplary block diagram of an inductive power system 10 in accordance with the present invention. The inductive power system 10 generally includes an inductive power pad 100, a power supply 130 (which may be included in the inductive power pad 100 in some embodiments), and a power receiver circuit 150. The inductive power pad 100 operates as a base from which a portable appliance 15 housing the power receiver circuit 150 is charged. For example, the inductive power pad 100 may be a flat base onto which the portable appliance 15 (e.g., a mobile telephone, digital camera, computer, remote control, music player, flash light, etc.) is placed for powering and/or recharging. The inductive power pad 100 is sized as appropriate to the proportions of the portable appliance 15 it is meant to recharge.

In this embodiment, the inductive power pad 100 includes a single transmitting inductor 120 operable to receive supply voltage 160 from the power supply 130, and to provide inductive energy 110 to in the power receiver circuit 150. The transmitting inductor 120 and the receiving inductor may be of implemented in various forms, for example, as planar spiral inductors having a particular number of whole or fractional windings.

The inductive power pad 100 further includes a detector circuit 140 coupled to the transmitting inductor 120, the detector circuit 140 operable to electromagnetically sense the presence of a power receiver circuit 150. The description “electromagnetically sense” refers to the detection of an electromagnetic signal (i.e., a signal having an electric, magnetic, or combined electromagnetic field) which is communicated between the detector circuit 140 and the power receiver circuit 150. In one embodiment, the detected electromagnetic signal is a modulated version of an ac magnetic field. In this embodiment, the inductive power pad generates an ac magnetic field which is inductively modulated by a magnetic field node disposed within a proximately-located power receiver circuit. The magnetic field node may be comprised from a soft magnetic layer or a resonant frequency circuit disposed within the power receiver circuit 150.

In another embodiment, the detected electromagnetic signal is a dc magnetic field which emanates from a magnetic field node composed of hard magnet disposed within the power receiver circuit 150, the dc magnetic field detected by a sensor in the inductive power pad 100. In still another embodiment, the electromagnetic signal is an electromagnetic RF signal, e.g. an RFID signal, which is transmitted from the power receiver circuit 150 to the detector circuit 140. Other embodiments may also be employed, whereby the detector circuit 140 electromagnetically senses the power receiver circuit 150. For example, the detector circuit 140 may broadcast a signal and the power receiver circuit 150 operates in a conventional transponder manner, whereby the power receiver circuit 150 transmits a predefined signal when it receives the transmit signal. More generally, any electric, magnetic or electromagnetic field may be used as the detection means to ascertain the presence of the power receiver circuit 150 proximate to the detector circuit 140. Each detector circuit 140, upon electromagnetically sensing the presence of the power receiver circuit 150, is operable to control switching its corresponding transmitting inductor 120 to the power supply 130. A supply voltage 160 is then applied to the corresponding transmitting inductor 120, thereby generating power 110 for transmission to the inductor 152 in the power receiver circuit 150.

In an exemplary embodiment, the detector circuit 140 is switchably coupled between the transmitting inductor 120 and the power supply 130, the detector circuit 140 operable to couple the transmitting inductor to the power supply 130. In another exemplary embodiment, the detector circuit 140 is operable to detect a recognized signal (e.g., a recognized RFID signal), and supply it to a receiver (e.g., an RFID receiver), the receiver operable to control coupling between the transmitting inductor 120 and the power supply 130.

FIG. 1B illustrates a second exemplary block diagram of an inductive power system 10 in accordance with the present invention. The inductive power system 10 generally includes an inductive power pad 100, a power supply 130 (which may be included in the inductive power pad 100 in some embodiments), and a power receiver circuit 150. The inductive power pad 100 operates as a base from which a portable appliance 15 housing the power receiver circuit 150 is charged. For example, the inductive power pad 100 may be a flat base onto which the portable appliance 15 (e.g., a mobile telephone, digital camera, computer, remote control, music player, flash light, etc.) is placed for powering and/or recharging. The inductive power pad 100 is sized as appropriate to the proportions of the portable appliance 15 it is meant to recharge. In this embodiment, the inductive power pad 100 includes a plurality of transmitting inductors 120₁-120ₙ (“n” referring to 2 or more, e.g., 5, 10, 50, 100, etc. transmitting inductors), each transmitting inductor 120 operable to receive supply voltage 160 from the power supply 130, and to provide inductive energy 110 to (i.e., to induce a voltage on) receiving inductor (illustrated below) in the power receiver circuit 150. The transmitting inductors 120 and the receiving inductor may be of implemented in various forms, for example, as planar spiral inductors having a particular number of whole or fractional windings.

The inductive power pad 100 further includes a plurality of detector circuits 140₁-140ₙ(“n” referring to 2 or more, e.g., 5, 10, 50, 100, etc.), each detector circuit 140 having a corresponding transmitting inductor 120 (e.g., detector circuit 140₁ corresponding to transmitting inductor 120₁), and each detector circuit 140 operable to electromagnetically sense the presence of a power receiver circuit 150. The description “electromagnetically sense” refers to the detection of an electromagnetic signal (i.e., a signal having an electric, magnetic, or combined electromagnetic field) which is communicated between the detector circuit 140 and the power receiver circuit 150. In one embodiment, the detected electromagnetic signal is a modulated version of an ac magnetic field. In this embodiment, the inductive power pad generates an ac magnetic field which is inductively modulated by a magnetic field node disposed within a proximately-located power receiver circuit. The magnetic field node may be comprised from a soft magnetic layer or a resonant frequency circuit disposed within the power receiver circuit 150.

In another embodiment, the detected electromagnetic signal is a dc magnetic field which emanates from magnetic field node composed of a hard magnet disposed within the power receiver circuit 150, the dc magnetic field detected by a sensor in the inductive power pad 100. In still another embodiment, the electromagnetic signal is an electromagnetic RF signal, e.g. an RFID signal, which is transmitted from the power receiver circuit 150 to the detector circuit 140. Other embodiments may also be employed, whereby the detector circuit 140 electromagnetically senses the power receiver circuit 150. For example, the detector circuit 140 may broadcast a signal and the power receiver circuit 150 operates in a conventional transponder manner, whereby the power receiver circuit 150 transmits a predefined signal when it receives the transmit signal. More generally, any electric, magnetic or electromagnetic field may be used as the detection means to ascertain the presence of the power receiver circuit 150 proximate to the detector circuit 140. Each detector circuit 140, upon electromagnetically sensing the presence of the power receiver circuit 150, is operable to control switching its corresponding transmitting inductor 120 to the power supply 130. A supply voltage 160 is then applied to the corresponding transmitting inductor 120, thereby generating power 110 for transmission to the inductor 152 in the power receiver circuit 150.

In an exemplary embodiment further detailed below, the detector circuit 140 is switchably coupled between its corresponding transmitting inductor 120 and the power supply 130, the detector circuit 140 operable to couple the corresponding transmitting inductor to the power supply 130. In another exemplary embodiment also detailed below, the detector circuit 140 is operable to detect a recognized signal (e.g., a recognized RFID signal), and supply it to a receiver (e.g., an RFID receiver), the receiver operable to control coupling between the corresponding transmitting inductor 120 and the power supply 130.

Further exemplary, the inductive power pad 100 is operable to concurrently supply inductive energy 110 to a multiplicity (e.g., 2, 5, 10, or more) of power receiver circuits 150. In such an embodiment, a respective multiplicity of detector circuits 140 (or multiple respective groups of detector circuits 140) are operable to electromagnetically sense, concurrently, the presence of the multiplicity of power receiver circuits 150, each of the detector circuits 150 operable to control switching of their respective transmitting inductors 120 to the power supply 130, as described herein.

In another embodiment, the inductive power pad 100 is operable to supply inductive energy 110 to a single power receiver circuit 150. In such an embodiment, a detector circuit 140 (or collective group of detector circuits 140) is operable to electromagnetically sense the presence of the power receiver circuit 150 and to control switching of its respective transmitting inductor 120 to the power supply 130, as described herein.

FIG. 2 illustrates a method of operating an inductive power system in accordance with the present invention. In particular, the method provides for the charging of a power receiver circuit 150 using an inductive power pad 100 having at least one transmitting inductor 120. In a particular embodiment of the invention, a plurality of transmitting inductors 120 (2 or more, e.g., 3, 5, 10, 50, 100, etc.) are employed, each transmitting inductor 120 operable to provide inductive energy 110 to the power receiver circuit 150.

At 212, a detector circuit 140 (or a plurality of detector circuits, one per the aforementioned plurality of transmitting inductors 120, above) electromagnetically senses a power receiver circuit 150. As noted above and described in greater detail below, the detector circuit 140 may employ means for detecting an electric field, a magnetic field, or an electromagnetic signal communicated between the detector circuit 140 and the power receiver circuit 150.

In one exemplary embodiment, operation 212 is carried out using the detector circuit 140 to detecting a change in an ac magnetic field which is generated by, and emanates from the detector circuit 140, the ac magnetic field inductively modulated by a soft magnetic layer disposed within a proximately-located power receiver circuit. The detector circuit 140 is further operable to exhibit a first operating parameter P₁ (e.g., impedance, operating frequency, etc.) when the soft magnetic layer inductively modulates the generated magnetic field, and a second operating parameter P₂ when the soft magnetic layer does not inductively modulate the generated magnetic field.

In another exemplary embodiment, operation 212 is performed by detecting a change in an ac magnetic field modulated by, and emanating from the detector circuit 140, the ac magnetic field inductively modulated by a resonant circuit disposed within a proximately located power receiver circuit. The detector circuit 140 is further operable to exhibit a first operating parameter P₁ (e.g., impedance, operating frequency, etc.) when the resonant circuit inductively modulates the generated magnetic field, and a second operating parameter P₂ when the resonant circuit does not inductively modulate the generated magnetic field.

In a further exemplary embodiment, operation 212 is carried out by detecting a dc magnetic field emanating from the power receiver circuit 150. The detector circuit 140 is operable to exhibit a first operating parameter P₁ (e.g., impedance, operating frequency, etc.) when the detector circuit 140 detects the dc magnetic field emanating from the hard magnetic layer of the power receiver circuit 150, and a second operating parameter P₂ when the detector circuit 140 does not inductively detect the dc magnetic field emanating from the hard magnetic layer of the power receiver circuit 150

In still a further exemplary embodiment, operation 212 is carried out by detecting an RF signal, e.g., an RFID signal, emanating from the power receiver circuit 150. Those skilled in the art will appreciate that other electric, magnetic, or electromagnetic signals may be used as well in alternative embodiments of the invention.

Once a proximately-located power receiver circuit 150 is electromagnetically sensed, the detector circuit 140 controls switching of its corresponding transmitting inductor 120 to the power supply 130, thereby applying a supply voltage 160 thereto from the power supply 130 (process 214). The supply voltage 160 provided to the one or more transmitting inductors 120 generates inductive energy 110 which is transferred to the power receiver circuit 150 (process 216). One exemplary embodiment of process 214 includes an architecture in which the detector circuit is switchably coupled between the power supply 130 and the detector circuit's corresponding transmitting inductor 120, the detector circuit 140 operable to switchably couple the power supply 130 to its corresponding transmitting inductors 120 when proximity of the power receiver circuit 150 is sensed thereby. In another exemplary embodiment of operation 214, the detector circuit provides a signal (e.g., a recognized RFID, signal further described below) to a receiver, the receiver operable to control the power supply to addressably connect to the corresponding transmitting inductor. These exemplary embodiments of the invention are further illustrated below.

### Magnetic Field Sensing

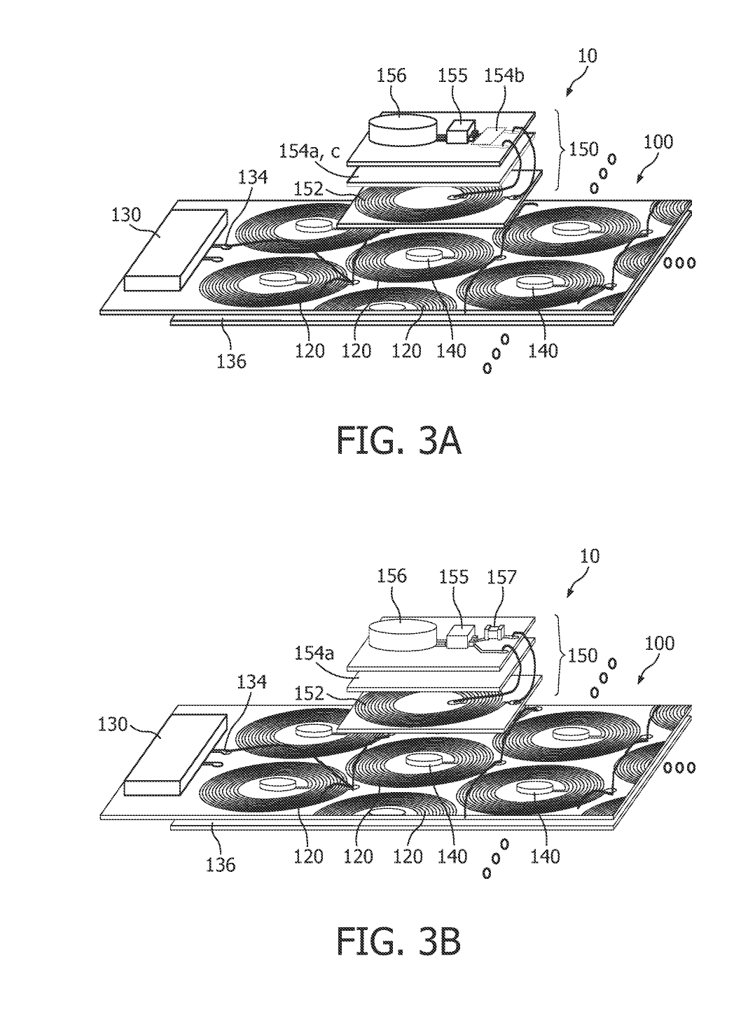

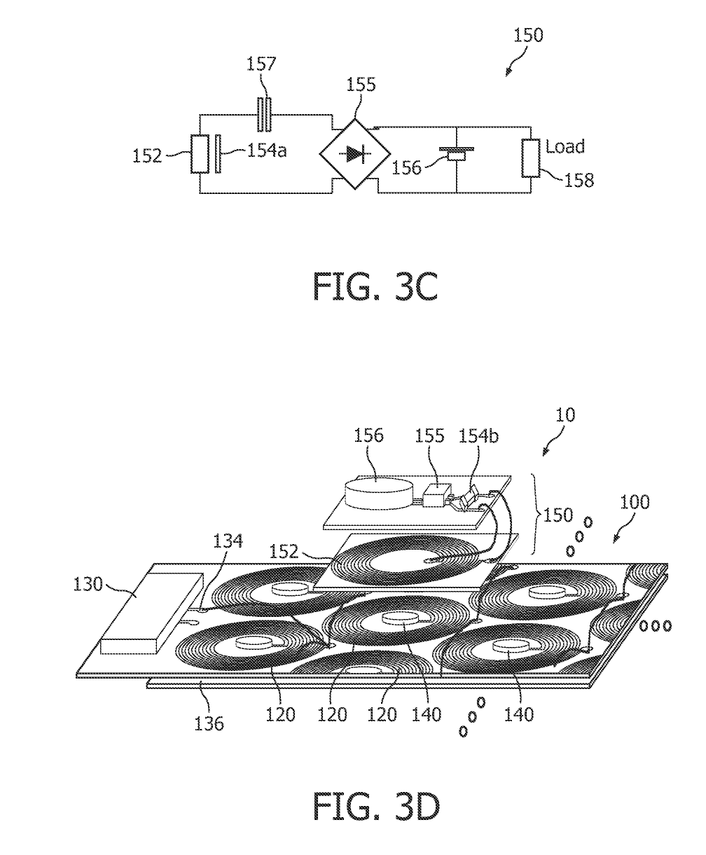

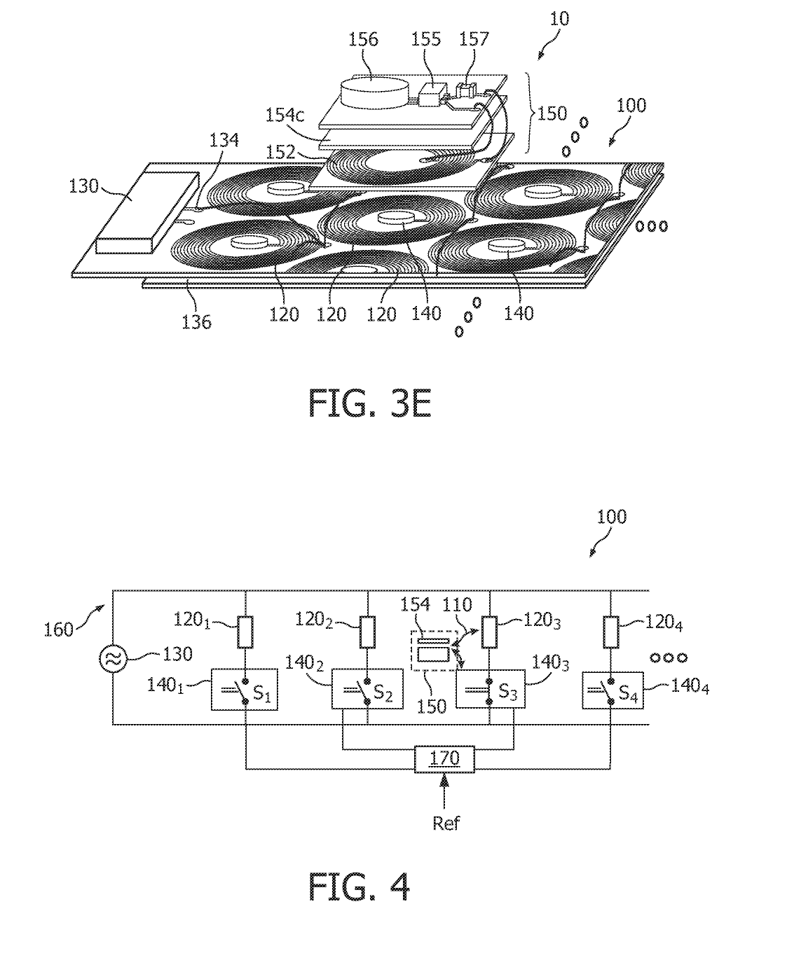

FIG. 3A illustrates a first exemplary inductive power system 10 in which a magnetic field is used to electromagnetically sense a power receiver circuit 150 in accordance with the present invention. While the example is shown in terms of a inductive power pad architecture having a plurality of transmitting coils and corresponding detector circuits 140 in accordance with the embodiment of FIG. 1B, the described features may also be implemented in the single transmitting inductor and corresponding detector circuit 140 architecture shown in FIG. 1A as well.

In the illustrated embodiment, an inductive power pad 100 includes a plurality of transmitting inductors 120 arranged in row and columns, each transmitting inductor 120 having an corresponding detector circuit 140 associated therewith. In the particular embodiment illustrated, each detector circuit 140 is located at/near the center of its corresponding transmitting inductor 120. Such an arrangement is advantageous in that electromagnetic sensing of the power receiver circuit 150 ensures proximity of the corresponding transmitting inductor 120 with the power receiver circuit 150. Other arrangements in which the detector circuit 140 is located outside the transmitting inductor 120 is possible as well in accordance with the present invention.

The inductive power pad 100 further includes a power supply 130 and a power supply line/bus 134 for providing power to each of the transmitting inductors 120. The power supply 130 may be located on the same circuit/board/substrate as the transmitting inductors 120, or may be positioned remotely, and electrically coupled thereto. Optionally, a transformer (not shown) may be coupled between the power supply 130 and the transmitting inductor 120 for transforming the power supply to the voltage/current required by the transmitting inductors 120, and/or to provide improved isolation between the power supply 130 and the transmitting inductors 120. As will be further illustrated below, each of the detector circuits 140 is switchably coupled between its corresponding transmitting inductor 120 and the power supply 130.

The inductive power pad 100 further includes a soft magnetic layer 136 operable to shield internal circuitry from the generated magnetic field of the transmitting inductors 120, as well as to increase the magnetic flux density in the direction of the power receiver circuit 150.

The power receiver circuit 150 (as used in FIG. 1A or 1B) is shown in FIG. 3A as disposed atop the center transmitting inductor 120. The power receiver circuit 150 may be employed in wireless devices, such as mobile telephones, personal digital assistants, digital cameras, flashlights, computers, MP3 players, remote controls, or other portable devices.

The power receiver circuit 150 includes a receiving inductor 152 (e.g., a spiral inductor), a magnetic field node 154 (three features 154a-154c shown; one, any two, or all three employed in exemplary embodiments of the invention), a rectifier 155 and a rechargeable battery 156. The spiral inductor 152 is operable to receive inductive power 110 transmitted by the transmitting inductor 120. The rectifier 155 is operable to rectify the received ac signal into a half or full wave rectified voltage/current which is subsequently delivered to the load of the portable appliance and/or to an optional rechargeable battery 156. Other storage devices, for example, a capacitor, may be used in an alternative embodiment of the invention.

The magnetic field node 154 is operable to provide magnetic field communication between the power receiver circuit 150 and the detector circuit 140. In one exemplary embodiment, the magnetic field node 154 is operable as a magnetic field modulator which alters a magnetic field emanating from the detector circuit 140 of the inductive power pad. In another embodiment, the magnetic field node 154 is implemented as a hard magnet operable to produce a dc magnetic field which can be sensed by the detector circuit 140. Each of these embodiments is further described below.

FIG. 3B illustrates a first embodiment of the power receiver circuit 150 (as used in FIG. 1A or 1B) in which the magnetic field node 154 is operable a magnetic field modulator. In the particular embodiment, a soft magnetic layer 154a is used to modulate an ac magnetic field generated by the detector circuit 140 of the inductive power pad 100, the soft magnetic layer 154a lowering the resistance of the magnetic flux density, and increasing the inductivity of the detector circuit 140. Such a change in the inductance of the detector circuit 140 is operable to trigger activation of the corresponding transmitting coil 120, as will be further described below. The soft magnetic layer 154a also serves to shield the receiver's internal circuitry from the generated magnetic field of the transmitting inductors 120. The soft magnetic layer 154a may be disposed as a large/wide area conforming to that the spiral inductors 152, or alternatively, disposed within the center of the spiral inductors 152 to provide greater sensing and positioning accuracy. The soft magnetic layer 154a may be a ferrite plate, or formed from such a material which can be easily laminated onto a printed circuit board or other substrate providing the bulk of the power receiver circuit 150a. For example, plastic ferrite compounds or structured high permeable metal foil (e.g., Mumetal, Metglas, Nanocrystalline iron, etc.) may be used.

A resonant capacitor 157 provides a capacitance, which in combination with the effective inductance of the receiving inductor, provides a resonant value which allows optimal energy transfer therethrough. The effective inductance of the receiving inductor 152 would be the inductance of the receiving inductor 152 occurring through mutual coupling between the transmitting inductor 120 and the receiving inductor 152 when the two windings 120 and 152 are brought into close proximity. Of course, other resonant or non-resonant circuit configurations may be implemented within the power receiver circuit 150, whereby power transfer from the receiving inductor 152 to the components 155, 156 and 157 is increased during power reception.

FIG. 3C illustrates an exemplary schematic of the power receiver circuit 150 shown in FIG. 3B in accordance with the present invention. The power receiver circuit 150 includes a receiver winding 152, a soft magnetic layer 154a, a resonant capacitor 157, a rectifier 155, a rechargeable battery 156, and optionally, a power consuming load 158. The receiving inductor 152 is operable to receive the inductive power 110 transmitted by the transmitting inductor 120. The soft magnetic layer 154a is operable to alter the magnetic flux of the ac magnetic field generated by the detector circuit 140. The resonant capacitor 157 provides a capacitance, which in combination with the effective inductance of the receiving inductor 152, provides a resonant value which allows optimal energy transfer therethrough. Rectifier 155 is operable to rectify the received ac signal into a half or full wave rectified voltage/current which is subsequently delivered to a rechargeable battery 156 as well as to the power consuming load 158 of the circuit 150. Other storage devices, for example, a capacitor, may be used in an alternative embodiment of the invention.

FIG. 3D illustrates another embodiment of the power receiver circuit 150 (as used in FIG. 1A or 1B) in which the magnetic field node 154 operates as a magnetic field modulator. In the particular embodiment, the magnetic field modulator is a resonant circuit formed by a capacitor 154b coupled in parallel with the receiving inductor 152. In such an embodiment, the inductance value of the receiving inductor 152 and the capacitance value of its parallel-coupled capacitor collectively provide a resonant frequency which substantially matches the operating frequency of the ac magnetic field generated by the detector circuit 140. The resonant circuit of the receiving inductor 152 and its parallel-coupled capacitor operates in a manner similar to that of the soft magnetic layer (154a, FIG. 3B), providing decreased magnetic flux resistance when placed in proximity to the detector circuit's ac magnetic field, the change in the ac magnetic field triggering the detector circuit 140 to switch power to the corresponding transmitting inductor 120.

FIG. 3E illustrates a further embodiment of the power receiver circuit 150 (as used in FIG. 1A or 1B) in which the magnetic field node 154 operates as a dc magnetic source. In the particular embodiment, the magnetic field node 154 is a hard magnetic layer 154c which produces a dc magnetic field that can be detected by the detector circuit 140. In such an embodiment, the detector circuit 140 may include a reed relay, hall sensor, or other sensor operable to detect a dc magnetic field.

For any of the embodiments shown in FIGS. 3A-3E, the inductive power pad 100 and the power receiver circuit 150 may each be constructed from a variety of materials, depending upon its required size, and intended operation. For the embodiment of FIG. 3B for example, the inductive power pad 100 and the power receiver circuit 150 may be constructed in a hybrid circuit form using discrete components housed on a printed circuit board. In such an embodiment, spiral inductors forming the transmitting inductors 120 may be constructed by masking and etching the printed circuit board to expose patterns of conductive material forming the transmitting inductors 120 and/or the power supply bus 134. The detector circuits 140, the power supply 130, the power supply line/bus 134, and the soft magnetic layer 136 on the inductive power pad 100 may be assembled onto the printed circuit board separate. The power receiver circuit 150 may be similarly formed, for example, as a printed circuit board housing the aforementioned receiving inductor 152, a soft magnetic layer 154a, and components 155, 156, and 157. As an example, the inductive power pad 100 may measure 20 cm (w)×30 cm (1) (e.g., A4 size) and include a matrix of 20-80 spiral inductors 120 (e.g., 1-5 cm in diameter) disposed on a printed circuit board over a soft magnetic layer 136. With the outer housings of the inductive power pad 100 and power receiver circuit 150 in contact, separation between the inductive power pad 100 and the power receiving circuit 150 for effective charging may vary, from 0.5-10 mm, for example. Contact between the inductive power pad 100 and the power receiver circuit 150 is not required, and the two systems 100 and 150 may be disposed apart as long as there is the desired degree of inductive coupling (e.g., less than −6 dB loss) therebetween.

Those skilled in the art will appreciate that other levels of integration may be employed as well. For example, one or both of the inductive power pad 100 and the power receiver circuit 150 may be implemented as a integrated circuit (e.g., Si, SiGe, GaAs, etc.), with the aforementioned components being monolithically formed into an integrated circuit using a photolithographic semiconductor process.

FIG. 4 illustrates an exemplary schematic of the inductive power system shown in FIG. 3A. As shown, the power supply 130 applies a supply voltage 160 to each of the transmitting inductors 120₁-120₄ via respective detectors 140₁-140₄. Each of the detector circuits 140 is switchably coupled between its corresponding transmitting inductor 120 and the power supply 130.

Each detector circuit 140₁-140₄ is further operable to electromagnetically sense the presence of a power receiver circuit 150 in proximity therewith by detecting the magnetic field node 154 of the power receiver circuit 150, the detector circuit 140 operable to couple its corresponding transmitter inductor 120₁-120₄ to the power supply in response. Each detector circuit 140 exhibits a first operating parameter P₁ in the presence of the magnetic field node of the power receiver circuit 150, and a second operating parameter P₂ outside the presence of the magnetic field node of the power receiver circuit 150, the first parameter P₁ resulting in coupling the circuit's corresponding transmitting inductor 120 to the power supply 130, and the second parameter P₂ resulting in decoupling the circuit's corresponding transmitting inductor 120 from the power supply 130. In particular, when a detector circuit 140 is in the presence of the magnetic field node 154 of a power receiver circuit 150, the magnetic field node 154 provides magnetic field communication between the power receiver circuit 150 and the detector circuit 140, thereby triggering the detector circuit's coupling of its corresponding transmitting inductor 120 to the power supply 130. When the detector circuit 140 is outside the presence of the magnetic field node of a power receiver circuit 150, no magnetic field communication occurs between the power receiver circuit 150 and the detector circuit 140.

Exemplary embodiments of the magnetic field node 154 include a soft magnetic layer (154a, FIG. 3B) or a resonant circuit (154b, FIG. 3D), each disposed within the power receiver circuit 150 and operable to modulate the ac magnetic field of the detector circuit 140. A hard magnetic layer (154c, FIG. 3E) disposed within the power receiver circuit 150 represents another exemplary embodiment of the magnetic field node 154. The operating parameters P of the detector circuits 140 may vary; for example, the operating parameter may be the impedance of a detector circuit 140, whereby the detector circuit 140 exhibits a first impedance Z₁ in the presence of the magnetic field node of the power receiver circuit, and a second impedance Z₂ outside the presence of the power receiver circuit's magnetic field node. In another exemplary embodiment, the operating parameter P is the detector circuit's frequency of operation. In such an embodiment, the detector circuit 140 operates at a first resonant frequency F₁ in the presence of the power receiver circuit's magnetic field node, and at a second resonant frequency F₂ outside the presence of the power receiver circuit's magnetic field node.

FIG. 4 illustrates a schematic view of the exemplary inductive power system shown in FIGS. 3A-E in accordance with the present invention. Particularly, detector circuits 140₁, 140₂, and 140₄ are operable with a second impedance Z₂ and/or at a second frequency F₂, each being outside the presence of a magnetic field node 154 of a power receiver circuit 150. Accordingly, detector circuits 140₁, 140₂, and 140₄ operate to decouple their corresponding transmitting inductors 120₁, 120₂, and 120₄ from the power supply 130. Detector circuit 140₃ is operable with a first impedance Z₁ and/or at a first frequency F₁, it being within the presence of a magnetic field node 154 of a power receiver circuit 150. Accordingly detector circuit 140₃ operates to couple its corresponding transmitting inductor 120₃ to the power supply 130. Supply voltage 160 is supplied thereto, and inductive power 110 is generated and supplied to the power receiver circuit 150.

The detector circuit 140 may be designed such that other operating parameters of the detector circuit 140 are altered in the presence of the power receiver circuit's magnetic field node. For example, a change in the detector circuit's current/voltage, phase/delay, may be used to indicate a presence of a magnetic field node of a proximate power receiver circuit 150.

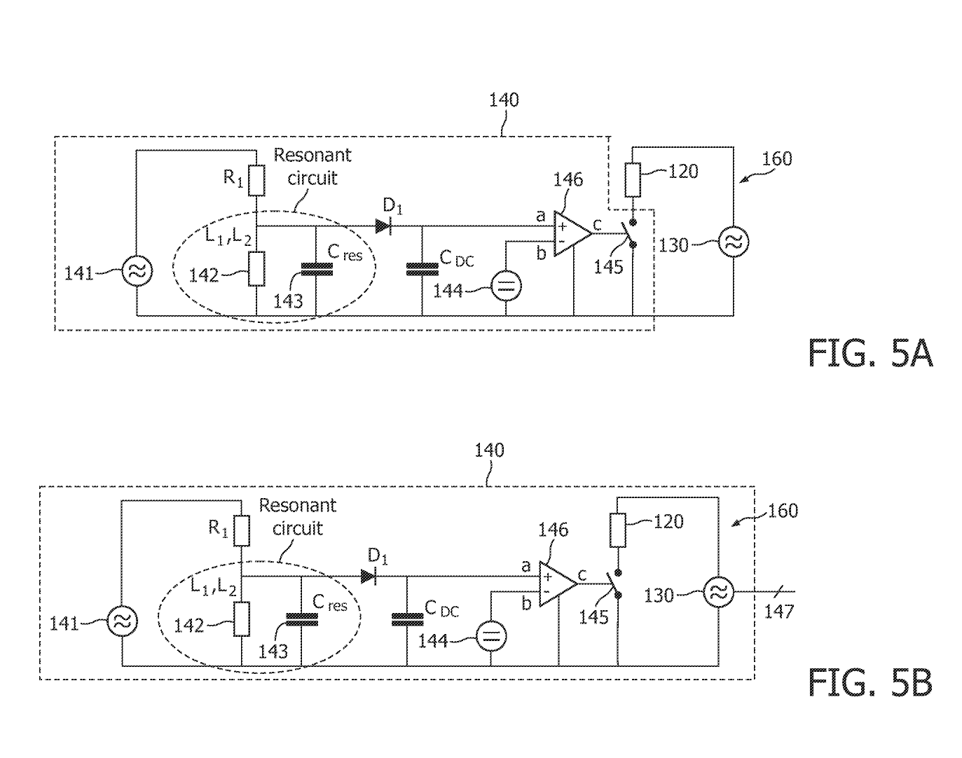

The threshold level of the detector circuits 140 to detect the magnetic field node of a proximately located power receiver circuit may be set in a variety of ways, depending upon which of the architectures shown in FIGS. 3A-3E the power receiver circuit employs. As an example for the power receiver circuit illustrated in FIG. 3E, the threshold level of each detector circuit 140 may be provided via its design, with each detector circuit 140 being operable to detect a magnetic field emanating from the power receiver circuit above a predefined field strength. In another embodiment in which the power receiver circuit 150 implements the designs shown in FIGS. 3A-3D, the threshold level may be set by a predefined minimum change in one or more of the aforementioned operating parameters in the detector circuit 140, such a change indicating a detected change in the ac magnetic field of the detector circuit which is caused by proximity of either a soft magnetic layer or a resonant circuit disposed in the power receiver circuit 150. Each detector circuit 140 may provide adjustment means (manual or automatic) for adjusting its threshold detection level. An exemplary detector circuit design is shown in FIG. 5 below.

Alternatively or in addition, an optional comparator 170 may be employed to sense the detection levels of the detector circuits 140₁₋₄, and thereby enable one or more detector circuits 140₁₋₄ to switch in their corresponding transmitting inductors 120₁₋₄ to the power supply 130. As an example, comparator 170 (which may be a multiple input device, or switchably coupled to one of the detector circuits 140₁-140₄) compares one or more operating parameters of the detector circuits 140₁-140₄ to a reference, comparator 170 sensing an operating parameter P₁ (e.g., an impedance Z₁, a resonant frequency F₁, or other parameter) indicative of the presence of a magnetic field node 154 in close proximity to the third detector circuit 140₃. Comparator may then assist detector circuit 140₃ to couple its corresponding transmitting inductor 120₃ to the power supply. Comparator 170 may be further operable to sense the operating parameters of the adjacently-located detector circuits 140₂ and 140₄, said parameters, for example, being slightly below each detector circuit's internally set threshold detection level, and thus switching out their corresponding transmitting inductors 120₂. If, for example, the operating parameters P for circuits 140₂ and 140₄ is within a predefined range of the threshold level, comparator 170 may enable detector circuits 140₂ and 140₄ to couple their corresponding transmitting inductors 120₂ and 120₄ to the power supply. In this manner, additional transmitting inductors 120₂ and 120₄ are activated to provide additional inductive energy 110 to the power receiver circuit 150. Such a process may be provided, for example, in applications requiring a high level of power consumption and/or a fast charging time.

Further alternatively, the comparator 170 can be employed to decouple one or several of the transmitting inductors 120₁-120₄ from the power supply 160 when all of the detector circuits 140 indicate the presence of a magnetic field node. In such an embodiment, the comparator 170 is operable to determine which of the detector circuits 140 is in closest proximity to the power receiver circuit 150 by determining which of the detector circuits' operating parameters are most strongly affected by the magnetic field node, and disable the connections from the other transmitting inductors 120 to the power supply 130. Such a condition may be determined, for example, by sensing which detector circuit 140₁-140₄ operates farthest away from a reference operating condition corresponding to absence of a power receiver circuit, or alternatively, which detector circuit operates closest to a reference operating condition corresponding to the presence of a power receiver circuit. The same effect may also be achieved by adjusting the threshold level of the detector circuits 140 higher until only one detector circuit 140 remains triggered. This process may be provided in applications in which relatively low power dissipation is expected and/or a slow charging time can be tolerated.

FIG. 5A illustrates a schematic view of a first exemplary detector circuit 140 employed in accordance with the present invention. The detector circuit 140 includes a signal generator 141, a detector inductor 142, a resonant capacitor 143, a reference voltage source 144, a switch 145, and a comparator 146.

The signal generator 141 is operable to provide a signal to parallel-coupled detector inductor 142 and resonant capacitor 143. In one embodiment, the signal generator 141 is a fixed frequency source, the signal being a coupled portion of the charging signal 160 provided by the power supply 130 if suitable.

The detector inductor 142 (which may be in the form of a spiral inductor) exhibits a first inductance L₁ in the presence of the magnetic field node 154 of the power receiver circuit 150, and a second inductance L₂ outside the presence of the magnetic field node 154 of the power receiver circuit 150. In an exemplary embodiment in accordance with FIG. 3B above, the detector circuit 140 generates an ac magnetic field, and the presence of the soft magnetic layer 154a of the power receiver circuit 150 modulates/alters the ac magnetic field. In particular, the soft magnetic layer 154a1 operates to increase the effective inductance of the detector inductor 142, and the voltage across the resonant circuit (inductor 142 and capacitor 143) will increase. The resulting increase in the effective circuit's inductance (i.e. impedance) produces a higher voltage on the non-inverting input 146a of the comparator 146. When the voltage at input 146a exceeds the reference voltage 144 applied to the inverting input 146b, the comparator output 146c swings high and activates the switch 145, coupled between the power supply 130 and the transmitting inductor 120, to close. Supply voltage 160 is subsequently provided to the corresponding transmitting inductor 120, at least a portion of which is inductively transferred to the power receiver circuit 150. In the foregoing manner, the detector circuit 140 is operable to couple its corresponding transmitting inductor 120 to the power supply 130 when the detector inductor 142 within the detector circuit 140 reaches a first inductance value L₁, the detector circuit 140 further operable to decouple its corresponding transmitting inductor 120 from the power supply 130 when the detector inductor 142 within the detector circuit 140 reaches a second inductance L₂.

In another embodiment, the signal generator 141 is a free running oscillator which will generally tune to the resonant frequency defined by a parallel-coupled detector inductor 142 and capacitor 143. In such an embodiment, the detector inductor 142 will have a first inductance value L₁ in the presence of a magnetic field node, the first inductance value L₁ and the capacitance 143 providing a first resonant frequency F₁ to which the signal generator 140 will tune, and a second inductance value L₂ outside the presence of a magnetic field node, the second inductance value L₃ and the capacitance 143 providing a second resonant frequency F₂ to which the signal generator 140 will tune. Detection as to what frequency the signal generator 141 is operating can serve as the basis for detecting proximity of the power receiver circuit 150 and controlling switch 145 in an open or closed state.

FIG. 5B illustrates a schematic view of a second exemplary detector circuit 140 employed in accordance with the present invention, with previously-identified features retaining their reference indicia. In this embodiment, each detector circuit 140 includes a dedicated ac generator 130 for providing a separate supply voltage 160 to the transmitting coil 120. A power supply bus 147 supplies power, in ac or dc state to the ac generator 130. In one embodiment, dc power is supplied along the power supply bus 147 to the ac generator, such an arrangement providing benefits in lower electromagnetic interference and ac noise which man accompany an ac power distribution system. Alternative to the illustrated configuration in which the power supply bus 147 is directly coupled to the dedicated ac generator 130 and the switch 145 completes the circuit between the dedicated ac generator 130 and the transmitting inductor 120, the circuit path where switch 145 is shown may be closed, and switch 145 repositioned so as to be coupled between the power supply bus 147 and the ac generator 130. In this arrangement, the ac generator is coupled to the power supply bus 147 when comparator 146 indicates the presence of a magnetic field node 154 (e.g., a soft magnetic layer 154a, a resonant circuit 154b, or a hard magnetic layer 154c disposed within the power receiver circuit), said presence indicated by a change in one or more operating parameters of the resonant circuit, such as a change in the impedance, resonant frequency, voltage, phase or other operating parameters.

Further optionally, the dedicated ac generator 140 of FIG. 5B may be configured so as to reduce potential electromagnetic interference with one or more neighboring detector circuits 140. In a specific implementation, separate ac generators 130 coupled to different (e.g., neighboring) transmitting inductors 120 supply separate supply voltages 160 operating at different frequencies to minimize EMI of adjacently-active ac magnetic fields. In another embodiment, separate ac generators 130 coupled to different (e.g., neighboring) transmitting inductors 120 may be configured to supply separate supply voltages 160 operating at different phases (e.g., 90 degrees out of phase) to reduce potential EMI interference of adjacently active ac magnetic fields. In each of these embodiments, the operating frequency or phasing of the supply voltage 160 provided by each detector circuit cell (“cell” referring to the coupled combination of a transmitting inductor 120 and its corresponding detector circuit 140) may be orthogonal to every other detector cell implemented on the inductive power pad, or the orthogonal operating frequency and phasing of the supply voltage 160 may repeat at a sufficient separation between groupings of detector circuit cells operating at the same frequency or phasing. Those skilled in the art will appreciate that other techniques may be used to minimize EMI interference between adjacent transmitting inductors as well.

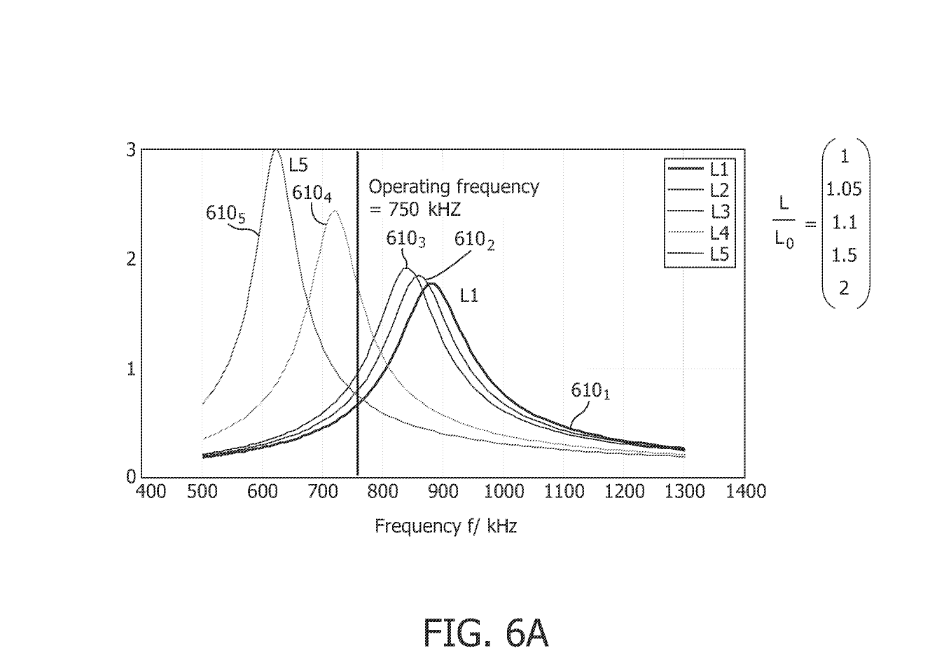

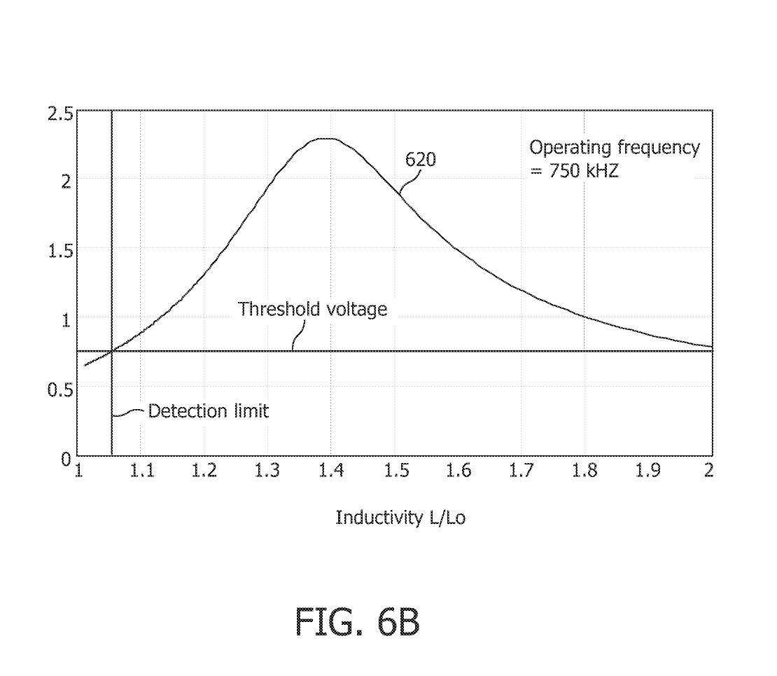

FIG. 6A illustrates impedance curves 610₁-610₅ of the detector circuit 140 shown in FIG. 5A in accordance with the present invention. The x-axis of the graph depicts frequency, and the y-axis shows relative impedance, normalized to 1 ohm.

Impedance curves 610₁-610₅ illustrates normalized impedance values of the detector circuit 140 for different inductivity ratios of the detector inductor 142 as its exposure to a soft magnetic layer is varied, factor 1 representing the condition in which the soft magnetic layer is located very far away from the detector circuit 140 (no sensed change in the inductance value of the detector inductor 142), and factor 2 representing the condition in which a soft magnetic layer is located very close to the detector circuit 140 (a 2:1 change in the inductance value of the detector inductor 142. An operating frequency point is selected between the two points (e.g., 750 kHz), and the values of the detector inductor 142 and capacitor 143 are selected to provide such a midway point. Responses 610₂ and 610₃ illustrate the resonant frequencies and normalized impedances for two distally-located soft magnetic layers/power receiver circuits, response 610₂ having an impedance response which is slightly below that of the impedance response of 610₃. Response 610₄ represents a proximately-located soft magnetic layer/power receiver circuit. As can be seen, when the detector inductor 142 is exposed to a soft magnetic layer in close proximity, the sensed voltage across the inductor 142 increases, and the resonant frequency shifts lower, thereby enabling detection of the power receiver circuit based on a change of the detector circuit's resonant frequency (using e.g., a free running oscillator 141) as described above. Presence of an undesired metal object within proximity of the detector inductor 142 operates to move the impedance lower and resonant frequency higher (its corresponding response being generally right of response 610₁), and accordingly the system is able to distinguish between a power receiver circuit employing a soft magnetic layer to which power is to be provided, and ordinary metal objects to which power is not to be provided.

FIG. 6B illustrates a voltage response of the detector circuit 140 shown in FIG. 5A in accordance with the present invention. Particularly, the sensed voltage across the detector inductor 142 is shown as a function of changes in the inductance value of the detector inductor 142. The x-axis depicts the inductance ratio of the detector inductor 142 which ranges from 1 to 2, as described in FIG. 6A. The y-axis shows sensed voltage across the resonant circuit (inductor 142 and capacitor 143), with response 620 being taken at a fixed signal generator frequency of 750 kHz, the mid-point operating frequency as described in FIG. 6A.

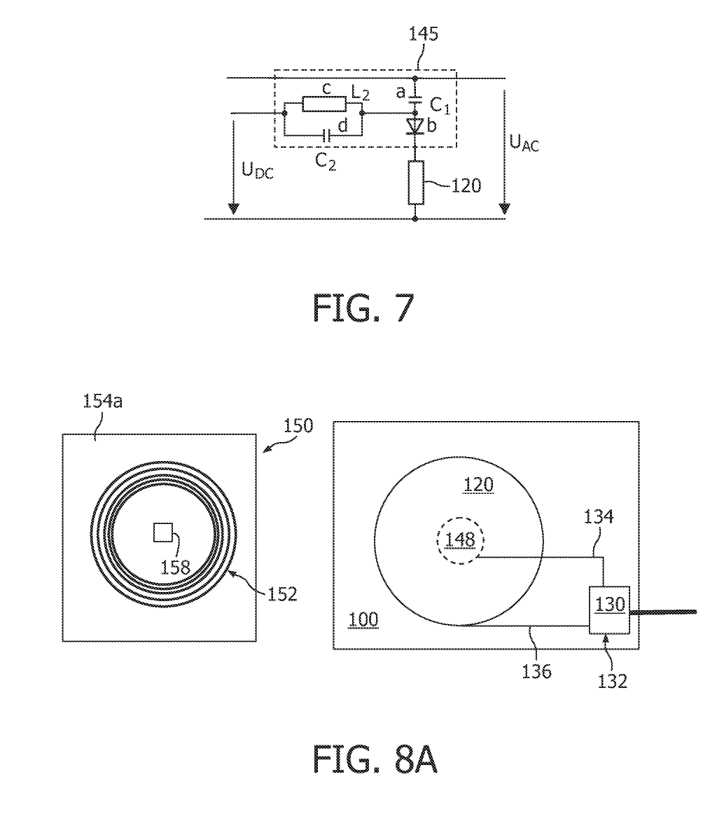

FIG. 7 illustrates an exemplary switch 145 employed in the detector circuit 140 of FIG. 5 in accordance with the present invention. Switch 145 includes a first capacitor 145a in series with a diode 145b, and a parallel-coupled inductor 145c and second capacitor 145d, the switch operable to switch an alternating current. First capacitor 145a blocks dc current or voltage from the ac supply. Inductor L2 provides diode 145b and the transmitting inductor 120 a positive offset dc current when the diode 145b conducts, and a negative offset dc voltage when the diode 145 does not conduct. Parallel-coupled inductor 145c and second capacitor 145d in combination with first capacitor 145b operate to minimize ac-dc coupling.

### RFID Sensing

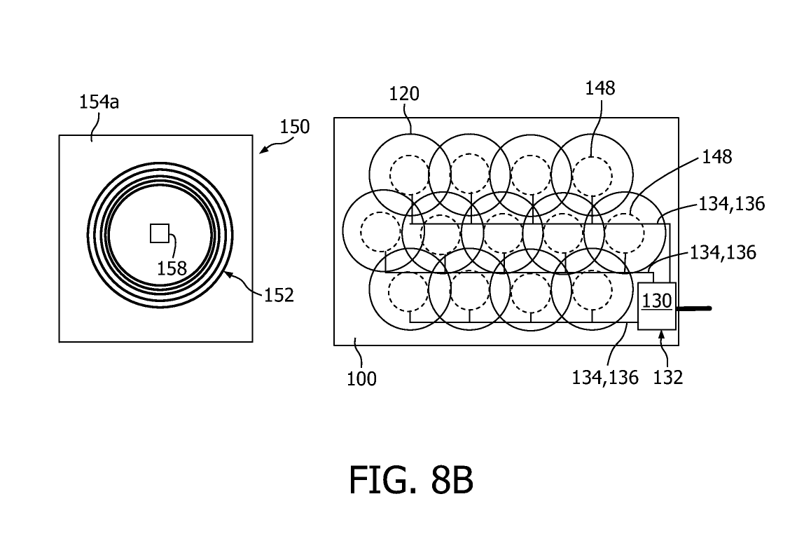

FIG. 8A illustrates an exemplary inductive power system in which RFID signals are used to electromagnetically sense a power receiver circuit in accordance with the invention. The portable appliance includes an RFID tag 158 (active or passive) operable to broadcast an RFID signature. In a particular embodiment of the invention, the RFID tag 158 is included within the power receiver circuit 150, although this arrangement is not mandatory, and the RFID tag 158 may be located in other parts/circuits of the portable appliance in an alternative embodiment. The power receiver circuit 150 further includes a receiving inductor 152, a soft magnetic layer 154a (uppermost layer shown) for reducing the magnetic flux of a proximately-generated ac magnetic field (produced, e.g., by a detector circuit 140 located on power pad 100), and power electronics (e.g., those shown in the embodiments of FIGS. 3A-3E) operable to rectify the inductive power received.

Within the inductive power pad 100, a detector circuit is formed as an RFID sensor 148 operable to detect the RFID signal transmitted from the RFID tag 158, the detected RFID signal subsequently supplied to an RFID receiver 132 (exemplary housed in the power supply 130) via a sensor bus 134. The RFID receiver 132 is operable to process the received RFID signal, which may be a RFID signal may be “recognized” or “unrecognized,” depending upon whether the RFID receiver 132 has been configured to receive and process the particular RFID signal or not. Further particularly, the RFID receiver 132 polls the RFID sensor 148 via a sensor bus 134. If a received RFID signal is recognized by the RFID receiver 132, the RFID receiver 132 controls the power supply 130 to couple to the transmitting inductor 120. The supply voltage is supplied to generate inductive energy for transfer to the power receiver circuit 150. If no RFID signal is received, or if a received RFID signal is not recognized by the RFID receiver 132, the RFID receiver 132 decouples the transmitting inductor 120 from the power supply 130.

In an exemplary embodiment, the RFID tag 158 is a passive RFID tag, and the RFID sensor 148 is realized as a coil disposed substantially centered within the transmitting inductor 120 corresponding thereto, the coil operable to detect an impedance modulated signal from a passive RFID tag 156.

The skilled person will appreciate the possibility of several alternatives to the foregoing described embodiment. For example, the transmitting coil 120 may serve as an RFID sensor. In this alternative embodiment, the RFID sensor 148 and sensor bus 134 could be omitted, and the power supply bus 136 would additionally serve as the sensor bus for communicating RFID signals to the RFID receiver 132 when located in the power supply 130, or for communicating control signals to the power supply when the RFID receiver is located within the transmitting coil cell. In such an embodiment, a combined power/sensor bus 136 would include filtering to provide attenuation of any high frequency power component transients from interfering with the data communicated between the sensor/transmitting coil 120 and the power supply 130.

In addition to providing location/proximity information, the RFID signal can be used to provide additional features as well. For example, the RFID receiver 132 can be set to control the power supply 130 to apply supply voltage to a transmitting inductor 120 only upon receipt of a particular RFID signal. In this manner, inductive charging/power consumption of a portable device may be controlled, e.g. a mobile phone or portable computer at an internet café.

Further exemplary, the RFID signal may provide particular information to the inductive power pad 100 as to its power consumption requirements, e.g., the RFID signal may provide information as to the required power transfer rate for charging/power consumption, an allowed time limit for the portable applicant as to the charging/power consumption, required/preferred frequency for the inductive energy 110 transferred, or other information. Further particularly, the RFID signal may provide identification information so that information (battery's age, history of use/charging) may be provided thereby or stored by a microprocessor (not shown) within the power supply 130.

FIG. 8B illustrates a second exemplary embodiment of an RFID inductive power system in accordance with the invention. The portable appliance includes an RFID tag 158 (active or passive) operable to broadcast an RFID signature. In a particular embodiment of the invention, the RFID tag 158 is included within the power receiver circuit 150, although this arrangement is not mandatory, and the RFID tag 158 may be located in other parts/circuits of the portable appliance in an alternative embodiment. The power receiver circuit 150 further includes a receiving inductor 152, a soft magnetic layer 154a (uppermost layer shown) for reducing the magnetic flux of a proximately-generated ac magnetic field (produced, e.g., by a detector circuit 140 located on power pad 100), and power electronics (e.g., those shown in the embodiments of FIGS. 3A-3E) operable to rectify the inductive power received.

Within the inductive power pad 100, the detector circuit is formed as an RFID sensor 148 operable to detect the RFID signal transmitted from the RFID tag 158, the detected RFID signal subsequently supplied to an RFID receiver 132 (exemplary housed in the power supply 130) via a sensor bus 134. The RFID receiver 132 is operable to process the received RFID signal, which may be a RFID signal may be “recognized” or “unrecognized,” depending upon whether the RFID receiver 132 has been configured to receive and process the particular RFID signal or not. Further particularly, the RFID receiver 132 polls each of the RFID sensors 148 via an addressable sensor bus 134. If a received RFID signal is recognized by the RFID receiver 132, the RFID receiver 132 controls the power supply 130 to address (via an addressable power supply bus 136) the transmitting inductor 120 corresponding to the RFID sensor 148 supplying the recognized RFID signal. Once the appropriate transmitting inductor 120 has been addressed by the power supply 130, supply voltage 160 is supplied to generate inductive energy 110 for transfer to the power receiver circuit 150. If no RFID signal is received, or if a received RFID signal is not recognized by the RFID receiver 132, the RFID receiver 132 controls the power supply to discontinue addressing of the transmitting inductor 120 corresponding to the RFID sensor 148 supplying the unrecognized RFID signal.

In an exemplary embodiment, the RFID tag 158 is a passive RFID tag, and the RFID sensor 148 is realized as a coil disposed substantially centered within the transmitting inductor 120 corresponding thereto, the coil operable to detect an impedance modulated signal from a passive RFID tag 156. Optionally, a comparator (using, for example, an RSS technique) may be employed to determine which one or many RFID sensors is the most proximate to the transmitting RFID tag when the RFID receiver 132 detects a recognized RFID signal from multiple RFID sensors 148. The skilled person will appreciate the possibility of several alternatives to the foregoing described embodiment. For example, each RFID sensor 148 may be coupled to its own dedicated RF receiver 132. In such an embodiment, the sensor bus 134 would be operable to communicate power to the RF receiver 132 and to detection signals therefrom to the power supply 130 for switching power to the corresponding transmitting coil 120 when a proper RFID signal is recognized thereby. Further alternatively, the transmitting coils 120 may themselves serve as an RFID sensor. In this alternative embodiment, the RFID sensor 148 and sensor bus 134 could be omitted, and the power supply bus 136 would additionally serve as the sensor bus for communicating RFID signals to the RFID receiver 132 when located in the power supply 130, or for communicating control signals to the power supply when the RFID receiver is located within the transmitting coil cell. In such an embodiment, the power/sensor bus 136 would include filtering to provide attenuation of any high frequency power component transients from interfering with the data communicated between the sensor/transmitting coil 120 and the power supply 130.

In addition to providing location/proximity information, the RFID signal can be used to provide additional features as well. For example, the RFID receiver 132 can be set to control the power supply 130 to apply supply voltage to a transmitting inductor 120 only upon receipt of a recognized RFID signal. In this manner, inductive charging/power consumption of a portable device may be controlled, e.g. a mobile phone or portable computer at an internet café.

Further exemplary, the RFID signal may provide particular information to the inductive power pad 100 as to its power consumption requirements, e.g., the RFID signal may provide information as to the required power transfer rate for charging/power consumption, an allowed time limit for the portable applicant as to the charging/power consumption, required/preferred frequency for the inductive energy 110 transferred, or other information. Further particularly, the RFID signal may provide identification information so that information (battery's age, history of use/charging) may be provided thereby or stored by a microprocessor (not shown) within the power supply 130.

Construction of the inductive power pad 100 and the power receiving circuit 150 is similar to that as described above. Exemplary, the RFID tag 156 is placed substantially centered within the power receiving winding 152 and the RFID coil 148 is located substantially centered within the transmitting inductor 120, such an arrangement providing accurate location information as to which transmitting inductor 120 is most proximately located to the receiving inductor. Separation between the inductive power pad and the power receiver circuit in the embodiments of FIGS. 8A and 8B may be made greater than in the magnetic field sensing systems of FIGS. 3A-3E due to the higher sensitivity of the RFID receiver. Separation between the transmitting and receiving inductors may be in the range of 1-2 cm in some embodiments.

### Exemplary Applications

As noted above, the inductive power system of the present invention can be implemented in a variety of portable appliances, for example a mobile telephone, digital camera, computer, remote control device, music player, flash light, as well as other portable devices. A particular application of the system is in the area of wireless control. For example, in the consumer electronics industry, the power receiver circuit 150 may be a chargeable wireless remote control which is operable to control the operation of a consumer device (e.g., computer, television set, audio entertainment system, etc.). In such an application, the inductive power pad 100 may be connected to the consumer device, e.g., coupled in line with the consumer device to receive power from the main power supply grid, or the inductive power pad 100 may store an auxiliary power supply for charging the wireless remote housing the power receiver circuit 150. In a further exemplary application the power pad 100 may be integrated into the housing of the consumer device, e.g. to store and charge a related wireless remote control device.

In the medical industry, a wireless control module may be used to control movement of a patient and/or operation and movement of equipment diagnosing and treating the patient. For example, the wireless control module may be implemented as a footswitch for controlling movement of a medical instrument or device, such as patient's chair in a dental office, or to control aspects of an x-ray diagnostic system, such as patient's table movement, gantry movement, release of x-rays, and the like (such instruments being referred to collectively as “medical devices”). Another application arises in the industrial area in which machines may be controlled by a wireless remote control unit.

Conventional foot switches which provide control by wired means are disadvantageous, as they required significant effort to clean and disinfect (e.g., when used in medical applications). Wireless operation is preferred; however, portable power supply via batteries is not reliable and presents difficulty in maintenance, as batteries must be periodically checked and replaced. Use of conventional rechargeable battery requires an exposed power transfer point to recharge the batteries, which potentially could leak. An inductive power system in which the control unit is sealed provides the best solution.

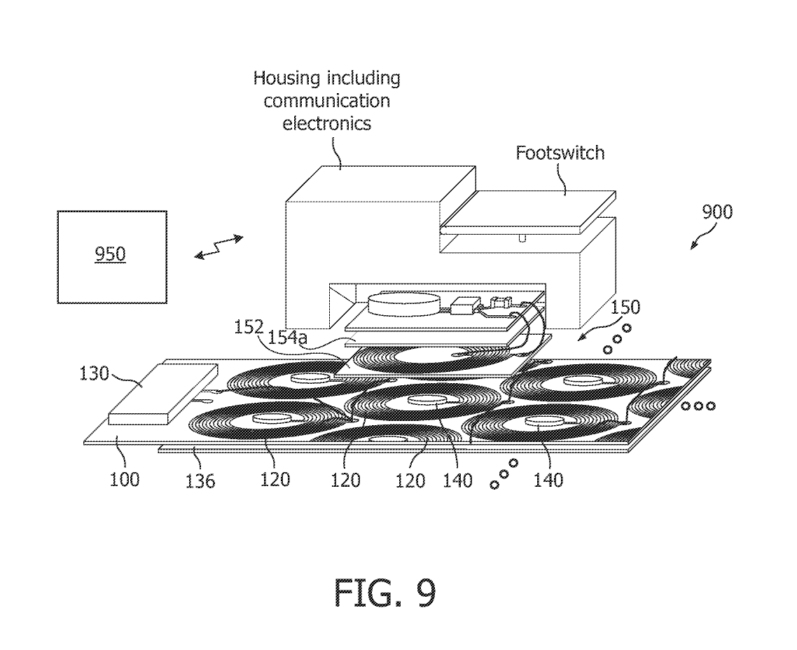

FIG. 9 illustrates a foot switch controller incorporating an inductive power system in accordance with the present invention. The foot switch controller 900 includes is operable for wireless communication with a wireless receiver 950, the foot switch controller 900 including a power receiver circuit 150 for receiving power from an inductive power pad 100.

In a particular embodiment, the foot switch controller 900 is operable to wirelessly control an x-ray apparatus 950, such as the movement of a patient bed, gantry or release of x-ray radiation in an x-ray scanning system, for example. While the illustrated embodiment shows one switch, the skilled person will understand that a number of different switches (2, 3, 5 or more switches) may be employed in a similar manner in accordance with the present invention.

The inductive power pad 100 may be constructed within a floor mat or embedded within a portion of the floor (collectively “transmitter area”) over which the foot switch controller 900 is placed to operate and/or for periodic charging. When constructed as a flexible mat, a flexible substrate is used in the construction of the transmitting inductors 120, e.g., polyimide (“Flexfoil”). The electronic components may also be located on top or below the transmitting inductors 120, or between them, the construction of the mat being suitable for the application of heavy loads on its top while remaining operable. The mat may be covered with a thin rubber layer on the backside to prevent it from slipping and a protection layer of the top surface. Further exemplary, the mat can be hermetically sealed to allow easy cleaning.

To achieve a uniform height that allows a good pressure distribution, an additional layer may be added to the flexible mat. This layer is made of a material, which is not compressed when stepping on it, and has the height approximately that of the electronic components, the layer having to accommodate electrical components. In this manner, the components are buried in the holes of the layer, and protected thereby. The holes may be additionally filled with epoxy to provide further protection.

The mat may further include an inclined area without inductors at the edges to avoid a step from the floor to the charging area. The edges can be made of a flexible material (e.g. rubber) to achieve a sealing function with respect to contaminating fluids, such that the bottom surface of the mat stays clean.

Passive electrical components of the inductive power pad 100 are preferably realized as printed circuit board integrated components. Semiconductor ICs may be thinned to reduce vertical height, and surface area reduced, so as to minimize risk of breakage.

When the inductive power pad is embedded in an area of the floor, said transmitter area may be equipped with borders, to facilitate retention of the foot switch controller 900 within this area. Further, the gap between the plane of the floor and the transmitting inductors 120 is filled with a material, such an epoxy plastic, which is fluid during installation and then fills all gaps and holes with minimal air gaps.

The housing of the foot switch controller 900 is preferably constructed from non-conducting material in order to avoid induced eddy currents that might cause unintended losses. In order to reduce loss of the induced energy 110, the receiving inductor (e.g. a spiral inductor) 120 is disposed in a hole which is of a slightly larger diameter than the spiral inductor 120. In an alternative embodiment, the housing has a recess which contains the matrix of spiral inductors 120, each of which face the exterior of the housing. The foot switch controller 900 may be equipped with an indicator lamp indicating that inductive power is being received and the charging status of the battery (when so equipped). In one embodiment, the foot switch controller contains no local energy storage and is only powered by the received inductive energy. Operation without a rechargeable power source simplifies the controller design, and reduces cost and maintenance needed for checking and eventually replacing a rechargeable battery.

The inductive power pad 100 and power receiver circuit 150 are shown as depicted in FIG. 3B, whereby a magnetic field node of the power receiver circuit 150 (supplied by a soft magnetic layer 154a therein, for example) is operable to alter an electrical parameter of one or more detector circuits 140 (e.g., a single one) within the charging pad 100. Alternatively, electromagnetic sensing may be accomplished through means of an RFID tag located within the portable foot switch (or the power receiver circuit 150 therein), and an RFID receiver within the power supply 130, as shown in FIG. 8. For example, the RFID tag and corresponding RFID receiver may be tuned to a unique signal, thereby preventing unauthorized use of the foot switch controller 900 in other areas, or interference from another foot switch controller.

Further exemplary, a floor cloth in accordance with the present invention may be formed by embedding copper wires or coils into a floor cloth during the floor cloth's production. The coils may be realized within the floor mat as either wire windings, or as foils, for example. Optionally, magnetic material, e.g., a ferrite polymer compound or Mumetal Foil can be used to improve the magnetic coupling between the floor cloth and the powered device. Further optionally, the floor cloth (e.g., the back/floor side thereof) may include marks or other indicia (e.g, pre-cut notches, etc.) indicating where along the floor cloth it may be cut in order to avoid cutting a transmitting inductor embedded therein. As the copper wires, foils with spiral windings and magnetic foils are all flexible, the resulting floor cloth can be handled right away as any other floor cloth and can be stored on a roll. The electronics required to operate the coils may be remotely located away from the floor cloth, e.g., in a base board of the room within which the floor cloth is located. In alternative embodiments, coils of the type mentioned above may be embedded in a carpet having a cable connection via which main power could be supplied to the carpet components. Further alternatively, parking spaces at road sides or in parking lots may be equipped with the charging functionality as described herein, thereby allowing hybrid or electric vehicles to be charged (via a power receiver circuit 150) while parked. Billing could be processed jointly with parking fees, or in other manners, using e.g., an RFID-enabled power receiver circuit and corresponding inductive power pad components, as described herein.

In summary, one aspect of the present invention is the electromagnetic sensing of a power receiver circuit 150 by a detector circuit 140, 148 within an inductive power pad 100. Once presence of the power receiver circuit 150 is sensed, the detector circuit 140, 148 operates to control switching of its corresponding transmitting inductor to a power supply to generate inductor energy 110 for transmission to the power receiver circuit 150. In this manner, the inductive power pad 100 generates inductive energy 110 only when a proximate power receiver circuit 150 is sensed.

As readily appreciated by those skilled in the art, the described processes may be implemented in hardware, software, firmware or a combination of these implementations as appropriate. In addition, some or all of the described processes may be implemented as computer readable instruction code resident on a computer readable medium (removable disk, volatile or non-volatile memory, embedded processors, etc.), the instruction code operable to program a computer of other such programmable device to carry out the intended functions.

It should be noted that the term “comprising” does not exclude other features, and the definite article “a” or “an” does not exclude a plurality, except when indicated. It is to be further noted that elements described in association with different embodiments may be combined. It is also noted that reference signs in the claims shall not be construed as limiting the scope of the claims.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined solely by the claims appended hereto.

1. An inductive power pad (100), comprising:
at least one transmitting inductor (120) operable to provide inductive energy (110) to a power receiver circuit (150); and
a respective at least one detector circuit (140, 148) coupled to a corresponding transmitting inductor, (120) each detector circuit (140, 148) operable to electromagnetically sense a power receiver circuit (150);
wherein each of the at least one detector circuit (140), upon electromagnetically sensing a power receiver circuit (150), is operable to control switching of its corresponding transmitting inductor (120) to a power supply (130), thereby coupling a supply voltage (160) to said corresponding transmitting inductor (120), said supply voltage (160) operable to generating inductive energy (110) for transmission to said power receiver circuit (150).

2. The inductive power pad (100) of claim 1, wherein the at least one detector circuit (120) comprises a plurality of detector circuits (120), each of the plurality of detector circuits (140) is switchably coupled between its corresponding transmitting inductor (120) and the power supply (130), and wherein each of the plurality of detector circuits (140) is operable to couple its corresponding transmitting inductor (120) to the power supply (130) when said detector circuit (140) detects a magnetic field node (154) of the power receiver circuit (150), said magnetic field node (154) operable to modulate one of more operating parameters P of the detector circuit (140).

3. The inductive power pad (100) of claim 2,
wherein said magnetic field node (154) comprises a soft magnetic layer (154a) disposed within the power receiver circuit (150),
wherein each of the plurality of detector circuits (140) is operable to generate a magnetic field which can be inductively modulated by the soft magnetic layer (154a), said each detector circuit (140) operable to exhibit a first operating parameter P1 when the soft magnetic layer (154a) inductively modulates the generated magnetic field, and a second operating parameter P2 when the soft magnetic layer (154a) does not inductively modulate the generated magnetic field, and
wherein said each detector circuit (140) is operable to couple the corresponding transmitting inductor (120) to the power supply (130) when operating at the first operating parameter P1, and wherein said each detector circuit (140) is operable to decouple the corresponding transmitting inductor (120) from the power supply (130) when operating at the second operating parameter P2.

4. The inductive power pad (100) of claim 2, wherein said each detector circuit (140) comprises a detector inductor (142) having a first inductance value L1 in the presence of the magnetic field node of the power receiver circuit (150), and a second inductance value L2 outside the presence of the magnetic field node of the power receiver circuit (150).

5. The inductive power pad (100) of claim 2,
wherein said magnetic field node (154) comprises a resonant circuit (154b) disposed within the power receiver circuit (150),
wherein each of the plurality of detector circuits (140) is operable to generate a magnetic field which can be inductively modulated by the resonant circuit (154b), said each detector circuit (140) operable to exhibit a first operating parameter P1 when the resonant circuit (154b) inductively modulates the generated magnetic field, and a second operating parameter P2 when the resonant circuit (154b) does not inductively modulate the generated magnetic field, and
wherein said each detector circuit (140) is operable to couple the corresponding transmitting inductor (120) to the power supply (130) when operating at the first operating parameter P1, and wherein said each detector circuit (140) is operable to decouple the corresponding transmitting inductor (120) from the power supply (130) when operating at the second operating parameter P2.

6. The inductive power pad (100) of claim 2,
wherein said magnetic field node (154) comprises a hard magnetic layer (154c) disposed within the power receiver circuit (150) and operable to emanate a dc magnetic field therefrom,
wherein each of the plurality of detector circuits (140) is operable to sense the dc magnetic field emanating from the hard magnetic layer (154c), said each detector circuit (140) operable to exhibit a first operating parameter P1 when said each detector circuit inductively detects the dc magnetic field emanating from the hard magnetic layer (154c), and a second operating parameter P2 when said each detector circuit does not inductively detect the dc magnetic field emanating from the hard magnetic layer (154c),
wherein said each detector circuit (140) is operable to couple the corresponding transmitting inductor (120) to the power supply (130) when operating at the first operating parameter P1, and wherein said each detector circuit (140) is operable to decouple the corresponding transmitting inductor (120) from the power supply (130) when operating at the second operating parameter P2.

7. The inductive power pad of claim 2, wherein each of the plurality of the detector circuits (140) includes a separate ac generator (130) coupled to provide a separate supply voltage (160) to a respective one of the plurality of transmitting inductors (120), and wherein a first of the ac generators (130) is operable to supply a power supply voltage (160) at a first phase or frequency to a first transmitting inductor (120), and a second of the ac generators (130) is operable to supply a power supply voltage (160) at a second phase or frequency to a second transmitting inductor (120).

8. The inductive power pad (100) of claim 1, wherein the at least one detector circuit (140) comprises a plurality of detector circuits (120), each of the plurality of detector circuits (140) comprises an RFID sensor circuit (148) operable to detect an RFID signal emanated from a power receiver circuit (150), the inductive power pad (100) further comprising an RFID receiver (132) coupled to receive an RFID signal from each of the plurality of RFID sensor circuits (148),
the RFID receiver (132) further operable to couple the power supply (130) to one or more of the plurality of transmitting inductors (120) in response to receiving a recognized RFID signal, and to decouple the power supply (130) from one or more of the plurality of transmitting inductors (120) in response to not receiving a recognized RFID signal.

9. The inductive power pad (100) of claim 8, wherein the RFID sensor (148) comprises a coil operable to detect load modulation of a passive RFID tag, the inductive power pad further comprising:
a sensor bus 134 addressably coupling each of the plurality of RFID sensors (148) to the RFID receiver (132); and
a power supply bus (136) addressably coupling each of the plurality of transmitting inductors (120) to the RFID receiver (132).

10. An inductive power system (10) comprising:
a power receiver circuit (150) operable to receive inductive power (110); and
an inductive power pad (100) as claimed in claim 1.

11. An inductive power system (10) of claim 1, further comprising a foot switch controller (900) coupled to receive power via the power receiver circuit (150), the foot switch controller (900) operable to wirelessly control a medical device (950).

12. An inductive power system (10) of claim 11, wherein the inductive power pad (100) is included within a floor mat, over which a foot switch controller (900) is placed.
Unifying Method of Operation, FIG. 2

13. A method for providing power to a power receiver circuit (150) using an inductive power pad (100), the inductive power pad having at least one detector circuit (140, 148) operable to electromagnetically sense a power receiver circuit, the at least one detector circuit (140, 148) coupled to a corresponding transmitting inductor (120), the transmitting inductor (120) operable to provide inductive energy (110) to the power receiver circuit (150), the method comprising:
one or more of the at least one detector circuit (140) electromagnetically sensing a power receiver circuit (150) proximate thereto;
coupling the corresponding transmitting inductor (120) to a power supply (130); and
applying a supply voltage (160) to the corresponding transmitting inductor (120),
wherein said supply voltage (160) supplied to said corresponding transmitting inductor (120) is operable to generate inductive energy (110) which transferred to the power receiver circuit (150).

14. The method of claim 13, wherein said at least one detector circuit (140, 148) comprises a plurality of detector circuits (140, 148), wherein one or more of the at least one detector circuit electromagnetically sensing a power receiver circuit (150) proximate thereto comprises at least one of the plurality of detector circuits (140) sensing proximity of a magnetic field node (154) disposed in the power receiver circuit (150).

15. The method of claim 14, wherein the magnetic field node (154) comprises a soft magnetic field layer (154a) disposed within the detector circuit (140), and wherein at least one of the plurality of detector circuits (140) sensing proximity of a magnetic field node comprises:
said at least one detector circuit (140) generating a magnetic field which can be inductively modulated by the soft magnetic layer (154a) disposed within the detector circuit (140);
said at least one detector circuit (140) exhibiting a first operating parameter P1 when the soft magnetic layer (154a) inductively modulates the generated magnetic field, and a second operating parameter P2 when the soft magnetic layer (154a) does not inductively modulate the generated magnetic field, and
wherein coupling the corresponding transmitting inductor (120) to a power supply (130) comprises:
coupling the corresponding transmitting inductor (120) to the power supply (130) when the said at least one detector circuit (140) operates at the first operating parameter P1; and
decoupling the corresponding transmitting inductor (120) from the power supply (130) when said at least one detector circuit (140) operates at the second operating parameter P2.

16. The method of claim 14, wherein the magnetic field node (154) comprises a resonant circuit (154b) disposed within the detector circuit (140), and wherein at least one of the plurality of detector circuits (140) sensing proximity of a magnetic field node comprises:
said at least one detector circuit (140) generating a magnetic field which is inductively modulated by the resonant circuit (154b) disposed within the detector circuit (140);
said at least one detector circuit (140) exhibiting a first operating parameter P1 when the resonant circuit (154b) inductively modulates the generated magnetic field, and a second operating parameter P2 when the resonant circuit (154b) does not inductively modulate the generated magnetic field, and
wherein coupling the corresponding transmitting inductor (120) to a power supply (130) comprises:
coupling the corresponding transmitting inductor (120) to the power supply (130) when the said at least one detector circuit (140) operates at the first operating parameter P1; and
decoupling the corresponding transmitting inductor (120) from the power supply (130) when said at least one detector circuit (140) operates at the second operating parameter P2.

17. The method of claim 13, wherein one or more of the at least one detector circuit electromagnetically sensing a power receiver circuit (150) proximate thereto comprises receiving a recognized RFID signal transmitted from the power receiver circuit (150).

18. A computer program product, resident on a computer readable medium, operable to provide instruction code for providing power to a power receiver circuit (150) using an inductive power pad (100), the inductive power pad having at least one detector circuit (140, 148) operable to electromagnetically sense a power receiver circuit, each of the at least one detector circuit (140, 148) coupled to a corresponding transmitting inductor (120), the transmitting inductor (120) operable to provide inductive energy (110) to the power receiver circuit (150), the computer program product comprising:
instruction code to control one or more of the at least one detector circuit (140, 148) to electromagnetically sense a power receiver circuit (150) proximate thereto;
instruction code to control the one or more detector circuits (140, 148) to couple the corresponding transmitting inductor (120) to a power supply (130); and
instruction code to control the one of more detector circuits (140, 148) to applying a supply voltage (160) to the corresponding transmitting inductor (120),
wherein said supply voltage (160) supplied to said corresponding transmitting inductor (120) is operable to generate inductive energy (110) which transferred to the power receiver circuit (150).
